(19) United States
(12) Patent Application Publication
(10) Pub. No.: US 2010/0288589 A1
(43) Pub. Date: Nov. 18, 2010

(54) BRAKE LINING SET HAVING DIFFERENT COMPRESSIBILITY

(76) Inventors: Robert Emmett, York (DE); Hans-Guenther Paul, Horhausen (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/681,939

(22) PCT Filed: Jul. 15, 2008
(86) PCT No.: PCT/EP08/05778

§ 371 Date: Jul. 21, 2010

(30) Foreign Application Priority Data
Oct. 9, 2007 (DE) 10 2007 048 363.7

(51) Int. Cl. F16D 65/092; F16D 55/2265; F16D 55/225

(52) U.S. Cl. 188/73.1; 188/250 G; 188/251 R

(57) ABSTRACT

The present invention discloses a brake pad set for a disc brake with a clamping device. This brake pad set comprises at least one first brake pad, which is arranged on the one side of the brake disc and a second brake pad, which is arranged on the other side of the brake disc. The brake pad set is characterized in that the friction pad of the first brake pad has a compressibility other than that of the friction pad of the second brake pad.

The present invention relates to a disc brake and more preferably a brake pad set for a disc brake.

Brakes generally serve for reducing or limiting the speed of moved machine parts or vehicles. The brake types used most frequently by far especially in vehicles are the shoe brake, the drum brake and the disc brake. Both the disc and also the drum brakes serve for converting kinetic energy taken off a rotating axle into heat. These are frequently employed in vehicles such as passenger cars and commercial vehicles, on railways but also in machines and plants in order to brake a movement or reduce a rotational speed.

In principle, disc brakes consist of a brake disc which co-rotates with the wheel in a force-connected manner against which brake shoes or brake pads are pressed from both sides. Depending on the design, single and multi-piston callipers as well as fixed, floating calliper and floating disc brakes are distinguished. Single-piston callipers only have one brake piston, these are mainly found in passenger cars as well as small motor cycles or sports bicycles. This design requires a floating calliper or a floating disc.

In the case of fixed calliper brakes the calliper is immoveable and brake pistons are located on both sides of the disc. A fixed calliper brake thus has twice as many brake pistons as a floating calliper brake and is therefore usually more expensive.

In contrast with a fixed calliper brake the floating calliper brake requires a brake carrier which is initially screwed to the wheel bearing housing. The floating calliper is then fastened to this carrier. The floating calliper engages about the disc and contains the brake pistons or clamping units with a pressure plate, which press the brake shoes or brake pads against the disc.

Floating calliper brakes thus have one or a plurality of pistons only on one side of the disc, the moveably suspended calliper transmits the pressure mechanically on to the other side of the brake disc. This is similar with the floating disc brake where the disc is moveably mounted. Advantages are lesser height, as a result of which the brake can be better positioned, and more economic manufacture.

Floating calliper brakes or floating disc brakes comprise at least two brake pads, one on the side of the brake disc facing the piston or the clamping unit of the brake, the so-called piston-sided brake pad, one on the side of the brake disc facing away from the piston or the clamping unit, the so-called fist-sided brake pad. The brake pads usually consist of a backing plate and a friction pad but employing only a friction pad is also possible.

One of the greatest problems with respect to brake pads among other things in the commercial vehicle field is the susceptibility to cracking of the brake disc. For this reason attempts are being made to design the friction pad so that at any rate even greater crack resistance of the brake disc is guaranteed. It is generally known that a high pad compressibility results in a good disc crack resistance. For this reason pads are employed which have a relatively high compressibility. However, it is also known on the other hand that a high pad compressibility can bring with it possible stroke problems of the brake. For this reason the maximum compressibility of the pad is restricted in that at least two pads are employed, with which it has to be ensured that the stroke requirement of the entire brake is not exceeded.

To date, at least two pads are employed according to the prior art which are similar in shape and type of the brake pads more preferably in the height of their compressibility value, so that these can be employed as both fist-sided as well as piston-sided brake pads.

However, with the new generation of the brakes as sole position feature it is explicitly desired that the fist-sided pad has a different shape and/or different characteristics from those of the piston-sided brake pad.

It is therefore the object of this invention to provide a brake pad set which can guarantee increased disc crack resistance without negatively influencing the stroke requirements of the brake and which can satisfy the sole position feature of the piston-sided or the fist-sided brake pad.

This object is solved through a brake pad according to Claim 1 of the present invention.

According to a first aspect of the present invention a brake pad set for a disc brake with a clamping device or a piston is provided. This brake pad set comprises at least one first brake pad, which is arranged on the one side of the brake disc and a second brake pad, which is arranged on the other side of the brake disc. The friction pad of the first brake pad has a compressibility that differs from that of the friction pad of the second brake pad. Through adaptation of the compressibility of the two brake pads to the individual circumstances of the brake the brake pad can be optimised with respect to its characteristics such as for example its contribution to the crack behaviour of the brake disc. Through the different compressibility the sole position feature is also satisfied.

Preferentially the clamping device of the disc brake is a one-sided clamping device. The first brake pad is arranged on the side of the brake disc facing away from the clamping unit. Since this brake pad is arranged on the side of the floating calliper which is reminiscent of a fist, this brake pad is also called fist-sided brake pad. The second brake pad is arranged on the side of the brake disc facing the clamping unit. For this reason this brake pad is also called piston-sided brake pad.

During tests with brake pads of disc brakes the inventors have discovered that substantially always the pad facing away from the clamping unit or fist-sided pad causes the larger cracks and that the pad facing away from the clamping unit or piston-sided pad is less critical in terms of crack susceptibility of the brake disc. In order to provide a disc brake which shows increased disc crack resistance with constant brake stroke requirement at the same time, the fist-sided pad should preferentially have a relatively high compressibility, whereas the less critical piston-sided pad can have a lower compressibility. For this reason the friction pad of the second brake pad preferentially comprises a compressibility which is at least 10% less than that of the friction pad of the first brake pad. The compressibility of the fist-sided pad can also have a compressibility which is higher by 15, 20, 25, 30, 35, 40, 50 or 75% than the piston-sided pad.

This solution thus offers the possibility of employing a pad on the fist side of the brake which has an extraordinarily high compressibility. Through the combination with the pad with lower compressibility on the piston side it is ensured that the maximum stroke requirement of the brake is not exceeded. Through the high compressibility of the fist-sided pad a substantially higher disc crack resistance is achieved.

According to a further exemplary embodiment the friction pad of the second brake pad can have an at least 10% higher compressibility than the friction pad of the first brake pad. As a result, it is possible to address even more specifically the conditions within the disc brake.

The friction pad of the first brake pad can either have a greater or lesser thickness than the friction pad of the second brake pad. Because of this it is possible to address the individual requirements of the brake disc and its surroundings.

Preferentially the fist-sided brake pad will have a greater thickness than the piston-sided brake pad since the former, due to its greater compressibility, can be exposed to greater wear and this can be compensated through a greater thickness.

Preferentially the first brake pad can have a shape that differs from that of the second brake pad. An example of this would be that the first brake pad is designed in mirror image to the second brake pad. Through this measure, the two brake pads cannot be mixed-up and thus have a sole position characteristic. Because of this it is not possible for the brake pad with the lesser compressibility to be installed on the fist side of the brake, as a result of which increased crack susceptibility of the brake disc could arise, as a consequence of which the brake would fail earlier.

The brake pad set can also have a carrier plate at least with the first brake pad or the second brake pad. Preferentially the brake pad set has a carrier plate both with the first brake pad as well as with the second brake pad. Through a carrier plate the contact pressure of the brake pad is evenly distributed over the entire friction area.

According to a further exemplary embodiment the carrier plate of the first brake pad has a thickness that differs from the carrier plate of the second brake pad. Here, too, the special requirements of each individual brake can be individually adapted so that for example the individual components of the brake are in force-connected contact with one another.

The friction pad of the second or the piston-sided brake pad should for example have a compressibility of 70 to 200 μm, preferentially a compressibility of 100 to 160 μm.

In contrast with this, the friction pad of the first brake pad for example has a compressibility of 200 to 330 μm, preferentially a compressibility of 240 to 300 μm. Because of this by adding the two compressibilities a total compressibility of the entire disc brake of approximately 400 μm could result. With a disc brake according to the prior art this would have meant that the two friction pads of the identical brake pads, which are employed on the fist side or the piston side, have a compressibility of 200 μm.

According to a further embodiment at least one of the brake pads can also comprise a hold-down spring.

Preferentially the brake pad set according to the invention is installed in a disc brake.

With the new brake designs a fist-sided pad can thus be employed with a compressibility of 270 μm combined with a piston-sided pad with a compressibility of 130 μm a combined compressibility of 400 μm can be employed and thus the crack resistance of the brake disc substantially increased without the brake stroke requirement being influenced negatively.

In the following, the present invention is explained by means of exemplary embodiments making reference to the drawing.

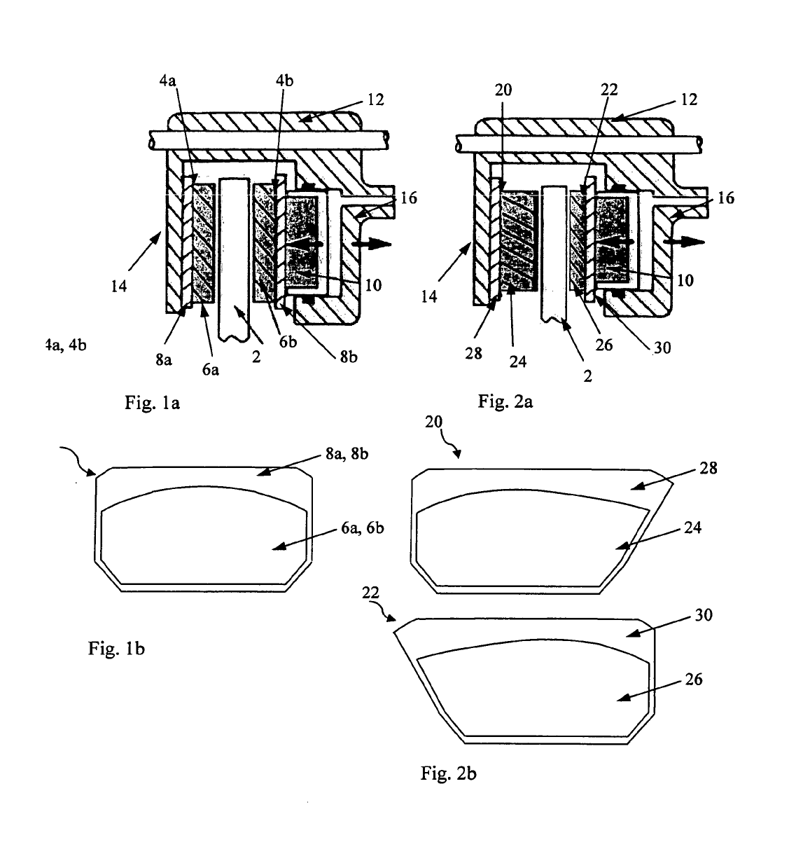

FIG. 1a shows a sectional drawing of a disc brake according to the prior art;

FIG. 1b shows a top view of a brake pad according to the prior art; which can be employed in the disc brake of FIG. 1a;

FIG. 2a shows a sectional drawing of a disc brake with a brake pad set according to an embodiment of the present invention;

FIG. 2b shows a top view of a brake pad set according to an embodiment of the present invention that can be employed in the disc brake of FIG. 1a.

FIG. 1a shows a brake disc according to the prior art. This comprises a floating calliper 12 with a fist side 14 and a piston side 16. The floating calliper 12 engages about the brake disc 2, which is located between the two identical brake pads 4a and 4b. The brake pads 4a and 4b each consist of an identical friction pad 6a and 6b and an identical carrier plate 8a and 8b. It is however also possible that the carrier plate is not present and the brake pads only consist of the friction pad. One of the identical brake pads 4a abuts the floating calliper on the fist side 14 and the other 4b abuts the piston 10, which is arranged on the piston side 16 of the floating calliper 12. If a pressure is exerted with the piston 10 on the piston-sided brake pad 4b (shown by the thick black arrows) it is pressed against the brake disc 2. In addition, the moveably suspended floating calliper 12 mechanically transmits the pressure also to the fist-sided brake pad 4a by means of the fist side 14. Through this design the two brake pads are evenly pressed on to the brake disc 2.

FIG. 1b shows one of the identical brake pads 4a and 4b from FIG. 1a. These brake pads are of symmetrical construction and each consists of a carrier plate 8a and 8b respectively and a friction pad 6a and 6b respectively, which is riveted, cast, welded, screwed or fastened to the carrier plate by means of a further joining method.

The brake pads 4a and 4b are identically worked, so that they can be employed both as fist-sided and as piston-sided brake pads. The compressibility of the two brake pads is added and the maximum stroke requirement of the brake must not be exceeded.

FIG. 2a shows a disc brake which is equipped with a brake pad set according to the invention. Here, too, the disc brake comprises a floating calliper 12 with a fist side 14 and a piston side 16. The floating calliper 12 engages about the brake disc 2 which is located between the two brake pads 20 and 22. The brake pad 20 here is arranged on the fist side 14 of the floating calliper 12 and consists of a friction pad 24 and a carrier plate 28. The brake pad 22 in contrast is arranged on the piston side 16 of the floating calliper 12 and consists of a friction pad 26 and a carrier plate 30. The fist-sided brake pad 20 comprises a friction pad 24, which compared with the friction pad 26 of the piston-sided brake pad has an at least 10% higher compressibility and a greater thickness. The fist-sided friction pad 24 can however also have the same thickness as the piston-sided friction pad 26. The outer shape of the fist-sided friction pad 24 is designed mirror-symmetrically to the piston-sided friction pad 26. It is however also possible that the shape of the fist-sided friction pad 24 and of the piston-sided friction pad 26 is the same or designed differently in another way. The carrier plate 28 of the fist-sided brake pad is designed mirror-symmetrically to the piston-sided carrier plate 30. It is however also possible that the shape of the fist-sided carrier plate 28 and the piston-sided carrier plate 26 is the same or designed differently in another way. In addition, however, it is also possible that the carrier plates are not present and the fist-sided brake pad 20 only consists of the friction pad 24 and the piston-sided brake pad 22 only consists of the friction pad 26.

If with the piston 10 a pressure is exerted on the piston-sided brake pad 22 (shown by the thick black arrows), it is pressed against the brake disc 2. In addition the moveably suspended floating calliper 12 by means of the fist side 14 mechanically transmits the pressure also to the fist-sided brake pad 20. Through this design, the two brake pads are evenly pressed on to the brake disc and the crack susceptibility of the brake disc is optimised through the high compressibility of the fist-sided friction pad 24.

FIG. 2b shows the fist-sided brake pad 20 and the piston-sided brake pad 22 as it can be employed in a disc brake according to FIG. 1a. These brake pads are constructed mirror-symmetrically. The fist-sided brake pad 20 consists of a carrier plate 28 and a friction pad 24 and the piston-sided brake pad 22 consists of a carrier plate 30 and a friction pad 26. The carrier plates 28 and 30 are embodied in mirror image, otherwise however identical in thickness and type. However, they can also be different in thickness, differently made or have a different shape. The friction pads 24 and 26 are also embodied counter-identical, the fist-sided friction pad 24 is embodied thicker than the piston-sided friction pad 26 and has a higher compressibility. The two friction pads can however also have the same shape and the same thickness. The friction pads 24 and 26 respectively are riveted, cast, welded, screwed to the respective carrier plate 28 and 30 or joined with one another by means of another joining method. However, brake pads 20 and 22 which only consist of the friction pads 24 and 26 are also possible.

As an example a friction brake is mentioned whose friction pads, because of stroke requirements, have to have a compressibility so that the overall thickness of the brake pads with maximum brake power can only be compressed by a maximum of 400 μm. With a disc brake according to the prior art this is only possible if both the fist-sided as well as the piston-sided brake pad have a compressibility where each of the brake pads can only be compressed by a maximum of 200 μm.

With the new brake design according to the present invention a fist-sided friction pad can be employed with a compressibility which can for example be compressed by a maximum of 270 μm with maximum brake pressure. If to this end a piston-sided friction pad with a compressibility is employed where the friction pad can be compressed by a maximum of 130 μm with maximum brake power, a combined compressibility of both brake pads is obtained where the brake pads with maximum brake power can be compressed by a maximum of 400 μm. Through this measure, the crack resistance of the brake disc is substantially increased without negatively influencing the brake stroke requirement.

1. A brake pad set for a disc brake comprising at least a first brake pad having a friction pad and a second brake pad having a friction pad, wherein the friction pad of the first brake pad has a compressibility different than that of the friction pad of the second brake pad.

2. The brake pad set according to claim 1, including a brake disc disposed between the friction pads and a clamping device comprising a one-sided clamping device, wherein the first brake pad is arranged on the side of the brake disc facing away from the clamping device and the second brake pad is arranged on the other side of the brake disc facing the clamping device.

3. The brake pad set according to claim 1, wherein the friction pad of the first brake pad has an at least 10% higher compressibility than the friction pad of the second brake pad.

4. The brake pad set according to claim 1, wherein the friction pad of the first brake pad has an at least 10% lower compressibility than the friction pad of the second brake pad.

5. The friction pad set according to claim 1, wherein the friction pad of the first brake pad has a greater thickness than the friction pad of the second brake pad.

6. The brake pad set according to claim 1, wherein the friction pad of the first brake pad has a lesser thickness than the friction pad of the second brake pad.

7. The brake pad set according to claim 1, wherein the first brake pad has a shape different than that of the second brake pad.

8. The brake pad set according to claim 1, wherein the first brake pad is designed mirror-symmetrically to the second brake pad.

9. The brake pad set according to claim 1, wherein the first brake pad comprises a carrier plate.

10. The brake pad set according to claim 1, wherein the second brake pad comprises a carrier plate.

11. The brake pad set according to claim 1, wherein both the first brake pad as well as the second brake pad each comprises a carrier plate.

12. The brake pad set according to claim 11, wherein the carrier plate of the second brake pad has a thickness that differs from the carrier plate of the first brake pad.

13. The brake pad set according to claim 1, wherein the friction pad of the first brake pad has a compressibility of 70 to 200 μm.

14. The brake pad set according to claim 13, wherein the friction pad of the second brake pad has a compressibility of 200 to 330 μm.

15. The brake pad set according to claim 1, wherein at least one of the brake pads comprises a hold-down spring.

16. (canceled)

17. The brake pad set according to claim 1, wherein the friction pad of the first brake pad has a compressibility of 100 to 160 μm.

18. The brake pad set according to claim 17, wherein the friction pad of the second brake pad has a compressibility of 240 to 300 μm.
